(19) United States
(12) Patent Application Publication
(10) Pub. No.: US 2006/0120214 A1
(43) Pub. Date: Jun. 8, 2006

(54) Mixing device

(75) Inventor: Spiros G. Raftis, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Red Valve Company, Inc.

(21) Appl. No.: 11/264,248

(22) Filed: Nov. 1, 2005

Related U.S. Application Data
(60) Provisional application No. 60/625,916, filed on Nov. 8, 2004.

(51) Int. Cl. B01F 15/00

(52) U.S. Cl. 366/165.2

(57) ABSTRACT

A deflector for a fluid mixing device includes a helical-shaped body having a first end, a second end, and a helical-shaped body between the first and the second ends. The helical body has two or more channels isolated from one another. In one non-limiting embodiment of the invention, the deflector is mounted in a cavity of a pipe between the first and second ends of the pipe to provide a mixing device having a first passageway connecting the first and the second ends of the pipe, and a second passageway connecting the first and the second ends of the pipe. The deflector in the pipe maintains the first and second passageways isolated from, and in a spaced relationship to, one another. Each of the passageways defines a hollow helical path as the distance from the first end toward the second end of the pipe increases.

### CROSS REFERENCE TO RELATED APPLICATION

This application is related to and claims the benefit of the filing date of U.S. Provisional Application Ser. No. 60/625,916, filed Nov. 8, 2004, and titled “Mixing Device”. U.S. Provisional Application Ser. No. 60/625,916 is incorporated herein in its entirety.

### BACKGROUND OF THE INVENTION

1. Field of the Invention

This invention relates to mixing devices and deflectors and, more particularly, to such devices which include structure for twisting or swirling fluid flow.

2. Discussion of the Prior Art

In the practice of mixing and blending fluids in pipelines, injecting chemicals into large tanks, and/or neutralizing effluent discharging into natural bodies of water, it is desirable to generate controlled turbulence in the flow stream(s) to improve the mixing of two or more fluids, e.g., mixing chemicals with water to change the chemistry of the water, e.g., the pH of the water. As can be appreciated by those skilled in the art, mechanical stirrers can be used for mixing bodies of fluids, e.g., water; however, a limitation of using mechanical stirrers is that they are disposed to physical wear and mechanical failure. Further, it is also appreciated by those skilled in the art that an advantage is realized by mixing the fluids in the pipes or conduits that carry the fluids, however, a limitation of mixing fluids in the pipes or conduits is that mixing fluids containing solid matter, sometimes referred to as slurries, can cause plugging of the pipes or conduits.

Although mixing devices are presently available, it would be advantageous to provide a mixing device that has improved performance, lower cost, less complex operating mechanism, and less maintenance requirements than the presently available mixing devices, and can mix slurries without plugging.

### SUMMARY OF THE INVENTION

This invention relates to a deflector for a fluid mixing device of the type having a pipe, a first end, a second end, a cavity between the first and second ends, and the deflector for use in the cavity of the pipe. In one non-limiting embodiment of the invention, the deflector includes a helical-shaped body having a first end, a second end, and two channels between the first and second ends with the two channels isolated from one another. With the deflector in the cavity of the pipe, the two channels and surface of the cavity of the pipe form a first passageway connecting the first end and the second end of the pipe, and a second passageway connecting the first end and the second end of the pipe with the first and second passageways isolated from one another and in a spaced relationship to one another.

In other non-limiting embodiments of the invention, the helical path of the first and second channels of the helical-shaped body each rotate through 270 degrees between the first and the second ends of the helical-shaped body, and the helical-shaped body has a location between the first and the second ends where the helical path of the first and second channels from the first end of the helical-shaped body to the location rotates through 180 degrees and from the location to the second end of the helical-shaped body rotates through 90 degrees, wherein optionally the location is selected from the group of (A) a distance from the first end of the helical-shaped body equal to ⅔ the distance between the first end and the second end, and the location is a distance from the second end of the helical-shaped body equal to ⅓ the distance between the first end and the second end to provide a fixed pitch helical deflector, and (B) a distance from the first end of the helical-shaped body greater than ⅔ the distance between the first end and the second end, and the location is a distance from the second end of the helical-shaped body greater than zero and less than ⅓ the distance between the first end and second end to provide a variable pitch deflector.

This invention also relates to a fluid mixing device having, among other things, a pipe having a first end and a second end; a first passageway within the pipe connecting the first end and the second end; and a second passageway within the pipe connecting the first end and second end, the first and second passageways isolated from one another and in a spaced relationship to one another. Each of the passageways defines a hollow, helical path along the length of the pipe.

In one non-limiting embodiment of the invention, the pipe of the mixing device is a one-piece molded pipe. In another non-limiting embodiment of the invention, the pipe of the mixing device has an interior cavity having an interior surface between and interconnecting the first end and second end. The mixing device further includes a deflector securely mounted in the interior cavity of the pipe between the first end and the second end to separate the interior cavity of the pipe into the first passageway and the second passageway.

The deflector of a non-limiting embodiment of the invention has a first major surface, an opposite second major surface, and a first end and an opposite second end, with the first end of the deflector in a fixed relationship to the first end of the pipe and the second end of the deflector in a fixed relationship to the second end of the pipe. The first surface of the deflector and adjacent portions of the interior surface of the cavity of the pipe provide inner walls of the first passageway, and the second surface of the deflector and adjacent portions of the interior surface of the cavity of the pipe provide inner walls of the second passageway.

In a further non-limiting embodiment of a mixing device of the invention, the pipe and the deflector are made of a compressible material. The pipe having the deflector is mounted in a housing, with the first end of the pipe connected to the first end of the housing and the second end of the pipe connected to the second end of the housing to provide a sealed chamber between inner surface of the housing and outer surface of the pipe. An opening is provided in a wall of the housing to move a fluid into the chamber to compress the pipe and the deflector, and for moving the fluid out of the chamber.

In a still further non-limiting embodiment of a mixing device of the invention, a duck bill valve is connected to the first end of the pipe of the mixing device.

In another non-limiting embodiment of a mixing device of the invention, the helical path of the first and second passageways each rotate through 270° between the first end and the second end of the deflector to provide either a fixed pitch helical deflector or a variable pitch helical deflector. More particularly, the deflector has a location between the first end and the second end, where the helical path of the first and second passageways from the first end of the deflector to the location rotates through 180° and from the location to the second end of the deflector rotates through 90°. In a fixed pitch helical deflector, the location is a distance from the first end of the deflector equal to ⅔ the distance between the first end and the second end of the deflector, and the location is a distance from the second end of the deflector equal to ⅓ the distance between the first end and the second end of the deflector to provide a fixed pitch helical deflector. In a variable pitch helical deflector, the location is a distance from the first end of the deflector greater than ⅔ the distance between the first end and the second end of the deflector, and the location is a distance from the second end of the deflector less than ⅓ the distance between the first end and the second end of the deflector to provide a variable pitch deflector.

The invention further contemplates using one or more of the non-limiting embodiments of the mixing devices in a mixing system and, optionally, having piping connecting the second end of the pipe of a first mixing device to the second end of the pipe of a second mixing device. For example and not limiting to the invention, the piping can include a pipe joint having three connectable ends, with one end of the pipe joint connected to one end of the first mixing device and a second end of the pipe joint connected to one end of the second mixing device.

### BRIEF DESCRIPTION OF THE DRAWINGS

FIG. 1 is a non-limiting embodiment of a fixed pitch helical deflector of the invention and includes FIGS. 1A-1F; FIG. 1A is an elevated top view of the fixed pitch helical deflector; FIG. 1B is a left elevated end view of FIG. 1A; FIG. 1C is a right elevated end view of FIG. 1A; FIG. 1D is an elevated side view of the fixed pitch helical deflector shown in FIG. 1A; FIG. 1E is a left elevated end view of FIG. 1D; and FIG. 1F is a right elevated end view of FIG. 1D.

FIG. 2 is a non-limiting embodiment of a variable pitch helical deflector of the invention and includes FIGS. 2A-2F; FIG. 2A is an elevated top view of the variable pitch helical deflector; FIG. 2B is a left elevated end view of FIG. 2A; FIG. 2C is a right elevated end view of FIG. 2A; FIG. 2D is an elevated side view of the variable pitch helical deflector shown in FIG. 2A; FIG. 2E is a left elevated end view of FIG. 2D; and FIG. 2F is a right elevated end view of FIG. 2D.

FIG. 3 is another non-limiting embodiment of a variable pitch helical deflector of the invention and includes FIGS. 3A-3F; FIG. 3A is an elevated top view of the variable pitch helical deflector; FIG. 3B is a left elevated end view of FIG. 3A; FIG. 3C is a right elevated end view of FIG. 3A; FIG. 3D is an elevated side view of the variable pitch helical deflector shown in FIG. 3A; FIG. 3E is a left elevated end view of FIG. 3D; and FIG. 3F is a right elevated end view of FIG. 3D.

FIG. 4 is a non-limiting embodiment of a mixing device of the invention having the variable pitch helical deflector shown in FIG. 2 positioned in a conduit and includes FIGS. 4A-4C; FIG. 4A is an elevated top view of the mixing device partially in cross section; FIG. 4B is a left elevated end view of the mixing device as shown in FIG. 4A; and FIG. 4C is a right elevated end view of the mixing device as shown in FIG. 4A.

FIG. 5 is another non-limiting embodiment of a mixing device of the invention having the variable pitch helical deflector shown in FIG. 2 positioned in a conduit of decreasing diameter and includes FIGS. 5A-5C; FIG. 5A is an elevated top view of the mixing device partially in cross section; FIG. 5B is a left elevated end view of the mixing device as shown in FIG. 5A; and FIG. 5C is a right elevated end view of the mixing device as shown in FIG. 5A.

FIG. 6 is still another non-limiting embodiment of a mixing device of the invention having a generally fixed pitch helical deflector molded in a conduit and includes FIGS. 6A-6F; FIG. 6A is an elevated top view of the mixing device; FIG. 6B is a left elevated end view of FIG. 6A; FIG. 6C is a right elevated end view of FIG. 6A; FIG. 6D is an elevated side view of the mixing device shown in FIG. 6A; FIG. 6E is a left elevated end view of FIG. 6D; and FIG. 6F is a right elevated end view of FIG. 6D.

FIG. 7 is a further non-limiting embodiment of a mixing device of the invention having the variable pitch helical deflector shown in FIG. 2 mounted in a flanged conduit and includes FIGS. 7A-7C; FIG. 7A is an elevated top view of the mixing device partially in cross section; FIG. 7B is a left elevated end view of the mixing device of FIG. 7A; and FIG. 7C is a right elevated end view of the mixing device of FIG. 7A.

FIG. 8 is an elevated side view, partially in cross section, showing an end of the mixing device of FIG. 7 mounted in a tank wall, with a portion of the mixing device extending into the tank interior.

FIG. 9 is another non-limiting embodiment of a mixing device of the invention having the variable pitch helical deflector shown in FIG. 2 mounted in a conduit having flanged ends and includes FIGS. 9A-9C; FIG. 9A is an elevated top view of the mixing device partially in cross section; FIG. 9B is a left elevated end view of the mixing device of FIG. 9A; and FIG. 9C is a left elevated end view of the mixing device of FIG. 9A.

FIG. 10 is an elevated side view, partially in cross section, showing the mixing device of FIG. 9 mounted to an outer tank wall.

FIG. 11 is another non-limiting embodiment of a mixing device of the invention having the variable pitch helical deflector shown in FIG. 2 mounted in a conduit having flanged ends, with ends of the deflector at the ends of the conduit, and includes FIGS. 11A-11C; FIG. 11A is an elevated top view of the mixing device partially in cross section; FIG. 11B is a left elevated end view of the mixing device of FIG. 11A; and FIG. 11C is a right elevated end view of the mixing device of FIG. 11A.

FIG. 12 is an elevated top view, partially in cross section, showing the mixing device of FIG. 11 mounted to an end of a Y-joint.

FIG. 13 is a view similar to the view of FIG. 12 showing the mixing device of FIG. 11 connected to two ends of a Y-joint.

FIG. 14 is a non-limiting embodiment of a flexible mixing device of the invention mounted in an air-operated pinch valve and includes FIGS. 14A and 14B; FIG. 14A is an elevated top view, partially in cross section, of the pinch valve; and FIG. 14B is an elevated side view, partially in cross section, of the pinch valve.

FIG. 15 is an elevated cross-sectional top view of a pipe arrangement incorporating features of the invention, the pipe arrangement having one end of a T-joint connected to the pinch valve having the mixing device shown in FIG. 14, and the mixing device shown in FIG. 11.

FIG. 16 is a still further non-limiting embodiment of a mixing device of the invention having the variable pitch helical deflector shown in FIG. 2 and an integral “duck bill” check valve in the closed position at the downstream end of the mixing device and includes FIGS. 16A-16F; FIG. 16A is an elevated top view of the mixing device partially in cross section; FIG. 16B is a left elevated end view of the mixing device of FIG. 16A; FIG. 16C is a right elevated end view of the mixing device of FIG. 16A; FIG. 16D is an elevated side view, partially in cross section, of the mixing device shown in FIG. 16A; FIG. 16E is a left elevated end view of the mixing device of FIG. 16D; and FIG. 16F is a right elevated end view of the mixing device of FIG. 16D.

FIG. 17 is a view of the mixing device shown in FIG. 16 having the “duck bill” check valve in the open position and includes FIGS. 17A-17F; FIG. 17A is an elevated top view, partially in cross section, of the mixing device; FIG. 17B is a left elevated end view of the mixing device of FIG. 17A; FIG. 17C is a right elevated end view of the mixing device of FIG. 17A; FIG. 17D is an elevated side view, partially in cross section, of the mixing device shown in FIG. 17A; FIG. 17E is a left elevated end view of the mixing device of FIG. 17D; and FIG. 17F is a right elevated end view of the mixing device of FIG. 17D.

### DETAILED DESCRIPTION OF THE PREFERRED EMBODIMENTS

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10.

Further, in the discussion of the non-limiting embodiments of the invention, it is understood that the invention is not limited in its application to the details of the particular non-limiting embodiments shown and discussed since the invention is capable of other embodiments. Further, the terminology used herein is for the purpose of description and not of limitation and, unless indicated otherwise, like reference numbers refer to like elements.

In the following discussion of non-limiting embodiments of the invention, one or more mixing devices or deflectors incorporating features of the invention are positioned inside and/or connected to one or more pipes, conduits, or tubes to generate a rotational or swirling motion to the fluid(s) passing through the pipe. Although in a preferred non-limiting embodiment of the invention, the internal surface of the pipe has a cylindrical shape having a circular cross section, e.g., to provide a cavity in the pipe, and a constant internal diameter between the ends of the conduit; the invention is not limited thereto. More particularly, the invention contemplates positioning one or more deflectors incorporating features of the invention in elongated pipes having incremental increasing and/or decreasing internal surface areas, e.g. but not limiting the invention thereto, a pipe having a cavity having a cylindrical shape having a circular cross section and increasing and/or decreasing diameter between the ends of the pipe. Further, the invention is not limited to pipes having a cavity having an internal circular cross section and includes but is not limited to internal cross-sectional surfaces that are, elliptical, polygonal, and combinations thereof, or any other cross-sectional shape. As can be appreciated by those skilled in the art, the outer surface of the pipe usually has the same contour as the inner surface of the pipe to reduce cost of manufacturing the pipe. The invention, however, contemplates a pipe having the inner surface contour different than the outer surface contour, the cross-sectional configuration of the inner surface different than the cross-sectional configuration of the outer surface. Still further, the invention is not limited to the material of the pipe, for example but not limiting the invention thereto, the pipe can be made of metal, non-metals, plastics, reinforced plastics, glass, concrete, and mixtures thereof.

The deflectors incorporating features of the invention are preferably made in the shape of a fixed or variable pitch helix, however, other configurations can be used without departing from the scope of the invention. For example but not limiting the invention thereto, the deflector can be a fixed pitch helix, a varied pitch helix, flat plates, curved plates, and combinations thereof. Further and not limiting to the invention, the helix can have two or more channels and the channel surfaces can be flat or ribbed. Still further and not limiting to the invention, the deflector can have any length, traverse any number of revolutions, and/or angular degrees. It has been determined that sufficient mixing can be obtained with deflectors having an angular rotation of 270° and/or a length of 4 inches (10.16 centimeters (“cm”)), although deflectors of shorter or longer lengths can be used in the practice of the invention. The invention is not limited to the material of the deflector of the invention. More particularly and not limiting to the invention, the mixing device and/or deflector can be made of a flexible elastomer, a flexible elastomer reinforced with fabric, a semi-rigid material such as polyvinylchloride (PVC), or a stiff material such as plastics, metals, glass or ceramic. In a non-limiting embodiment of the invention, the mixing device and deflector are made of a flexible material in order that the mixing device and deflector can be compressed using air pressure to control the shape of the mixing device, as discussed below.

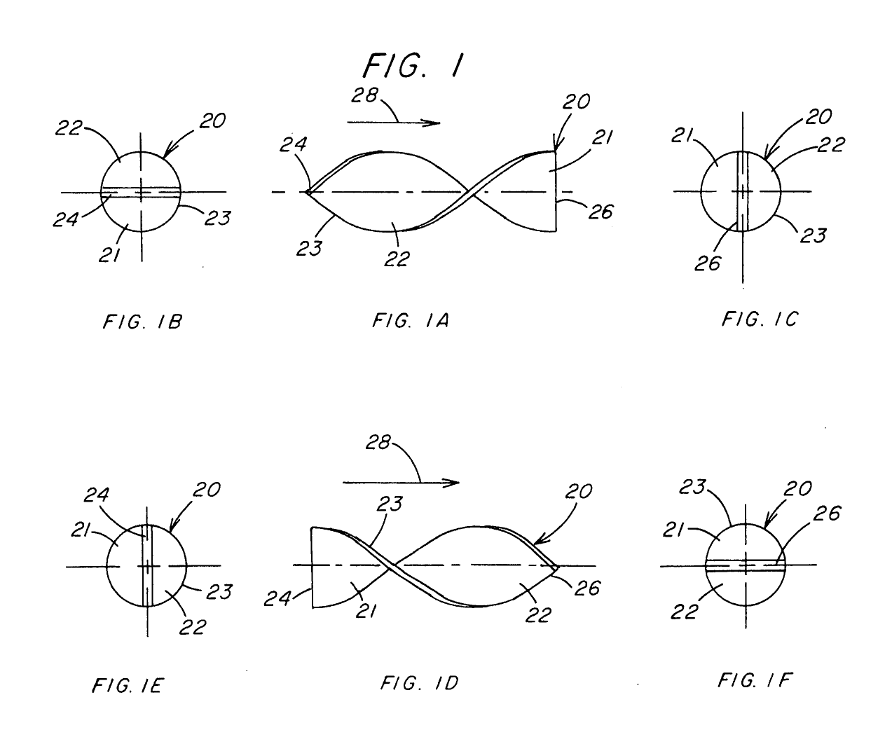

With reference to FIG. 1 there is shown a fixed pitch helical deflector 20 incorporating features of the invention having two flow channels 21 and 22. The deflector 20 shown in FIG. 1 is not positioned in a pipe, conduit, or tube for purposes of clarity. The rotation or twist of deflector body 23 is constant from end 24 to opposite end 26, i.e., along the direction of flow shown by arrow 28. The twist can be clockwise as shown in FIG. 1 or counterclockwise. In practice, as the process fluid engages the end 24 of the deflector 20, there is an abrupt change in direction of the flow stream of the process fluid, e.g. and not limiting to the invention, the flow changes from a generally laminar flow to a circular flow.

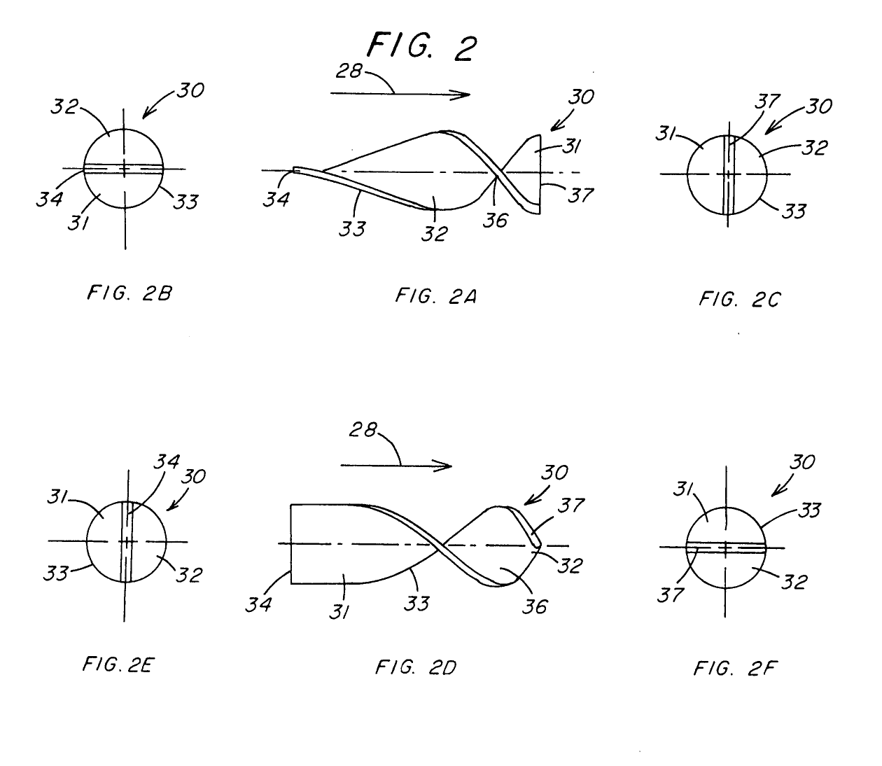

The abrupt change in the direction of the flow stream caused by engaging the end 24 of the fixed pitch deflector 20 generates more energy loss in the process fluid than energy loss realized by the change in the direction of the flow stream caused by engaging the end of a variable pitch helical deflector, e.g. but not limiting the invention thereto, a variable pitch deflector 30 of the invention shown in FIG. 2 and discussed below. As the process fluid travels along the length of the deflector 20, the flow stream stabilizes and the exit profile of the flow stream is similar to that of the variable pitch deflector. As can now be appreciated, the fixed pitch deflectors incorporating features of the invention are not as efficient as the variable pitch deflectors incorporating features of the invention discussed below. An advantage, however, of the fixed pitch deflectors over the variable pitch deflectors is lower tooling cost and lower manufacturing cost. Although not limiting to the invention, it is preferred that the twist of the deflector take advantage of the gravitational forces acting on the fluid as it moves over the deflector and out of the mixing device(s). More particularly, as is known by those skilled in the art, water moving out of the bowl of a toilet moves from right to left, i.e., in a counterclockwise direction above the equator, and left to right, i.e., in a clockwise direction below the equator. Having the rotation or twist of the deflector to provide the mixing device with rifling in a right to left direction, i.e., counterclockwise direction above the equator, and to provide the mixing device with a rifling in a left to right direction, i.e., clockwise direction below the equator, takes advantage of the gravitational force acting on the fluid as the fluid moves through and out of the mixing device.

With reference to FIG. 2 there is shown the variable pitch helical deflector 30 incorporating features of the invention having two flow channels 31 and 32. The deflector 30 in FIG. 2 is not shown positioned in a conduit for purposes of clarity. The rotation or twist of deflector body 33 gradually increases from end 34 along the direction of flow as indicated by the arrow 28 to position 36, e.g., straight ahead from the end 34 to approximately 45 degrees at end 37 of the deflector 30. As can now be appreciated, the rotation or twist of the deflector body 33 can gradually increase from end 34 along the direction of flow as indicated by the arrow 28 to the end 37 of the deflector 30 to provide the deflector 30 with a variable pitch along its entire length, e.g., similar to the deflector shown in FIG. 5 and discussed below. Although not limiting to the invention, the end 34 of the deflector 30 faces the process fluid moving in a downstream direction. The process fluid moving over the end 34 toward the position 36 of the body 33 of the deflector 30 gradually changes direction. From the position 36 to the end 37 of the deflector 30, the change in direction of the process fluid is constant. The gradual change in direction of the process fluid along the variable portion of the variable deflector provides for a minimum of internal turbulence and, consequently, a minimum of energy loss in the flow stream.

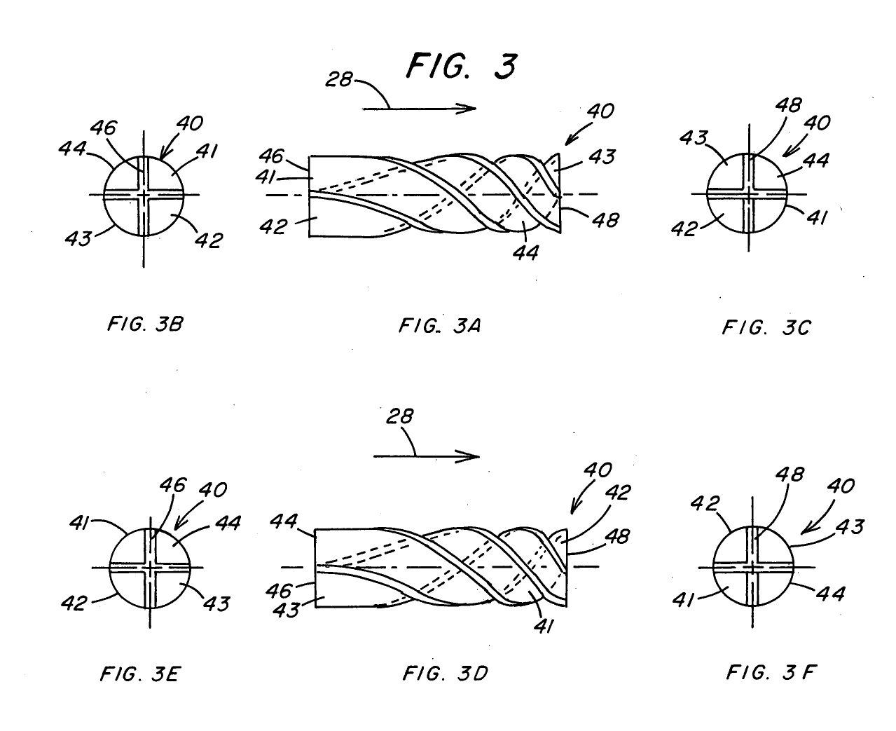

With reference to FIG. 3 there is shown a variable pitch helical deflector 40 incorporating features of the invention having four flow channels 41-44 between ends 46 and 48. The deflector 40 in FIG. 3 is not shown positioned in a conduit for purposes of clarity. As can now be appreciated, the deflector of the invention can have any number of flow channels, for example 2, 3, 4, 5, 6, etc.

The discussion will now be directed to non-limiting embodiments of the invention using the deflectors of the invention in pipes, conduits, or tubes to provide mixing devices or mixing nozzles. In the following discussion, the deflector 30 shown in FIG. 2 is discussed, however, as can be appreciated, any deflector, e.g. but not limited to the deflectors 20 and 40 shown in FIGS. 1 and 3, respectively, can be mounted in a pipe to provide a mixing device embodying features of the invention.

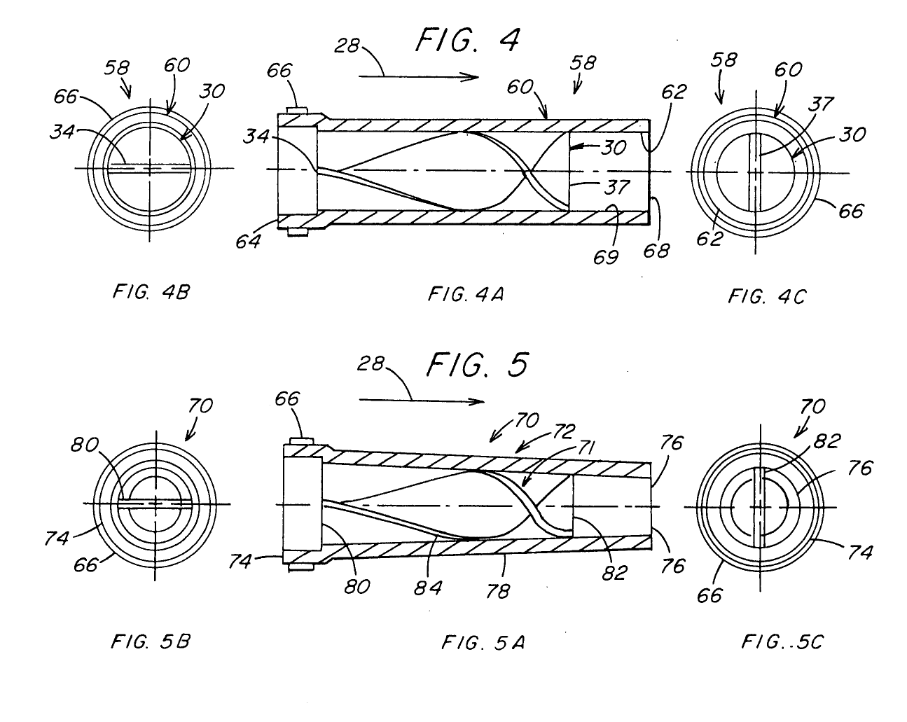

With reference to FIG. 4 there is shown a mixing device or mixing nozzle 58 having the variable pitch helical deflector 30 shown in FIG. 2 positioned inside a “slip-on” pipe, conduit, or tube 60. The deflector 30 can be either an integral part of the pipe 60 or a separate component that is assembled to inner surface 62 of the pipe 60 in any convenient manner, for example but not limiting to the invention, by adhesives, mechanical fastening devices, and groove and tongue arrangements. Inlet end 64 of the pipe 60 is shaped to slip on to a mating pipe (not shown) and held in place with a suitable fastener or clamp 66. Although not limiting to the invention, it is preferred that discharge end 68 of the pipe 60 extends beyond the end 37 of the deflector 30 by a length designated by the number 69. The length 69 is approximately equal to the inside diameter of the pipe 60 to allow the swirling action of the process fluid moving over the deflector 30 to fully develop beyond the confines, i.e., upstream of the end 37 of the deflector 30, before discharging into a receiving media, e.g., a body of fluid (not shown in FIG. 4). As can be appreciated, the length 69 of the pipe 60 can be equal to more than one pipe diameter, and can be less than one pipe diameter, e.g., zero, in those instances where the swirling action need not be fully developed beyond the confines of the defector 30. The mixing device 58 shown in FIG. 4 having the inlet end 64 of the pipe 60 connected to an end of a source of process fluids and an unconnected or free discharge end 68 is suitable for discharging swirling process fluids into a large body of fluid, such as a tank, pool, pond, river, bay or ocean (not shown in FIG. 4).

Shown in FIG. 5 is a mixing device or nozzle 70 having variable pitch helical deflector 71 positioned inside a tapered or “cone” shaped slip-on pipe, conduit, or tube 72. The pipe 72 has a larger inlet end 74 than discharge end 76 to provide a tapered body 78 between the ends 74 and 76. The details of the construction of the mixing device 70 except for tapered body 78 are similar to the details of construction for the mixing device 58. The deflector 71 incorporating features of the invention has an end 80 adjacent inlet end 74 of the mixing device 58 larger than opposite end 82 to provide a deflector-tapered body portion 84 between the deflector ends 80 and 82. The details of construction for the deflector 30 shown in FIG. 2 are similar for the deflector 71 shown in FIG. 5 except for the tapered body portion 84 of the deflector 71. Although the reduced area of the discharge end 76 generates energy losses, it also results in increased discharge velocity, which, in turn, improves mixing of the body of fluid into which the process fluid exiting the discharge end 76 is discharged. As can be appreciated, the invention contemplates having end 76 of the mixing device 70 as the inlet end and end 74 of the mixing device as the outlet end.

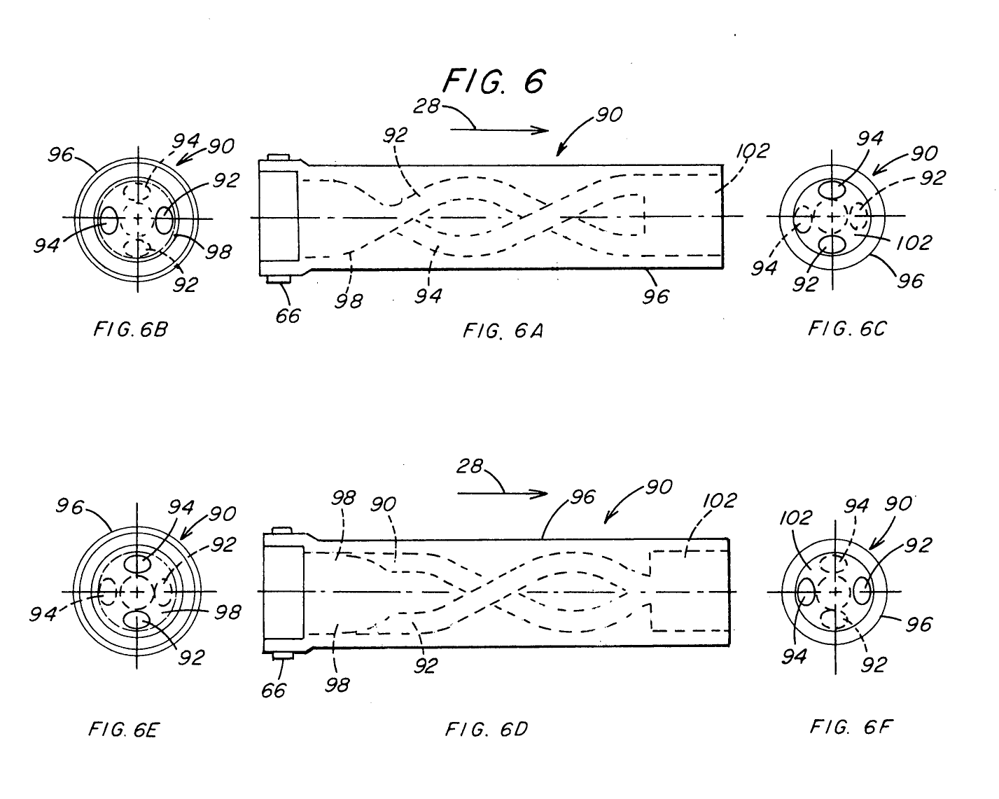

Shown in FIG. 6 is a mixing device or nozzle 90 having bent or twisted passageways 92, 94 molded in cylindrical pipe or member 96. The member 96 has tapered inlet end 98 for smooth entrance of process fluid into the member 96 and moving in the direction of flow shown by the arrow 28 through the passageways 92 and 94, during which time the process fluid has a swirling or twisting motion and flows into outlet end 102. The passageways 92 and 94 have a fixed pitch helical shape; however, the invention contemplates the passageways 92 and 94 having a variable pitch helical shape. As can be appreciated, the invention is not limited to the number of flow passageways and the invention contemplates any number of passageways for the fluid medium to pass through, e.g., 1, 2, 3, 4, 5, etc., passageways. The cross-sectional shape of passageways 92 and 94 do not need to be circular but can be any reasonable shape that facilitates manufacture, for example, but not limiting to the invention, square, rectangular, elliptical, oval, trapezoidal, polygonal, and combinations thereof. The circular shape allows the mold to be made in a most straightforward manner, e.g. but not limiting the invention, to using circular cross-sectional steel rod formed into the shape of a helix. The helix is then molded into a slip-on pipe. The clamp 66 is used to securely mount the slip-on pipe to an end (not shown) of a pipe carrying process fluid.

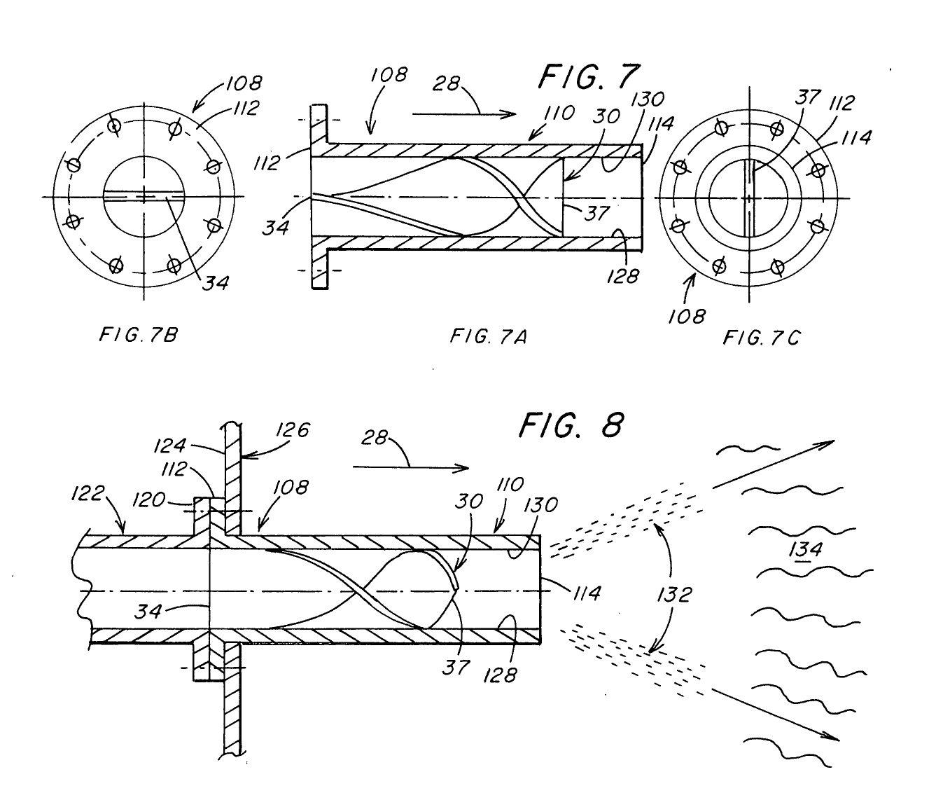

With reference to FIG. 7, mixing device or nozzle 108 incorporating features of the invention includes a 4-inch (10.16 cm) diameter variable pitch deflector, e.g., the variable pitch deflector 30 shown in FIG. 2, mounted inside a conduit, tube or pipe 110 having a flanged inlet end 112 adjacent to, e.g., aligned with, the end 34 of the deflector 30. As can be appreciated, the invention is not limited to the diameter of the deflectors, and the diameter of the deflectors can be any size, e.g. but not limiting the invention thereto, diameters of 1 inch (2.54 cm) to 100 inches (254 cm), and diameters of 4 inches (10.16 cm) to 96 inches (243.84 cm). Opposite flanged outlet end 114 of the pipe 110 is spaced from the end 37 of the deflector 30. In one non-limiting embodiment of the invention and with reference to FIGS. 7 and 8, the flanged end 112 of the pipe 110 can be connected to flanged end 120 of pipe, conduit, or tube 122 carrying process fluids and to outer wall 124 of tank 126 as shown in FIG. 8, with suitable fasteners and gaskets (not shown).

During operation, the fluid stream passes from the end 120 of the pipe 122 into end 112 of the mixing device 108 in an axial direction and, in this case, is separated into two separate flow streams as the fluid stream passes over the deflector 30. The variable helical deflector 30 imparts a rotational velocity component to the flow stream, and as the flow stream leaves the end 37 of the deflector 30, the flow stream re-combines into a single “swirling” flow in portion 128 of inner surface 130 of the pipe 110 between the end 37 of the deflector 30 and the end 114 of the pipe 110. The process fluid now has two vector components. The first vector component is axial and pushes the process fluid straight out into the tank into the receiving body of fluid 134. The second vector component is radial and pushes outward from the swirling component and pushes the process fluid radically outward after it leaves the end 114 of the pipe 110. The process fluid exits the mixing device 108 as a fluid stream 132 having the shape of a hollow circular cone flow pattern discharging into the receiving body of fluid 134. The hollow circular cone shape has a substantially larger surface area compared to a simple circular jet that would be produced if a deflector of the invention was not used. The increased surface area of the process fluid exiting the mixing device 108 significantly increases mixing between the process fluid and the receiving fluid body. As can be appreciated by those skilled in the art, two or more mixing devices with the same or opposite rotational directions can be installed in the same tank wall, with the exact locations and orientations selected to optimize the mixing within the tank.

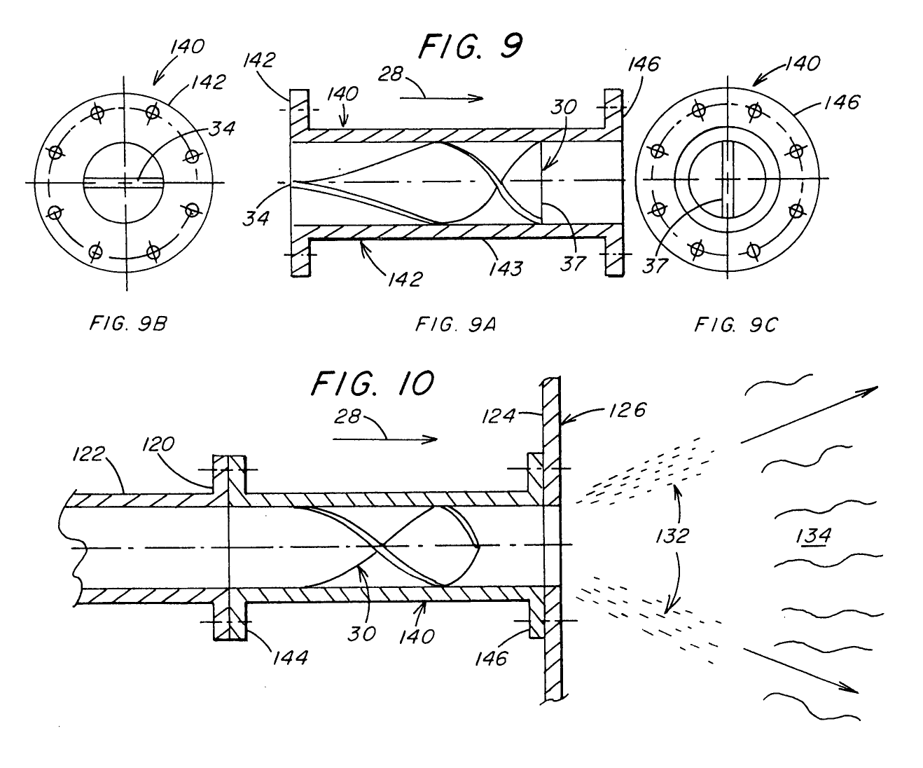

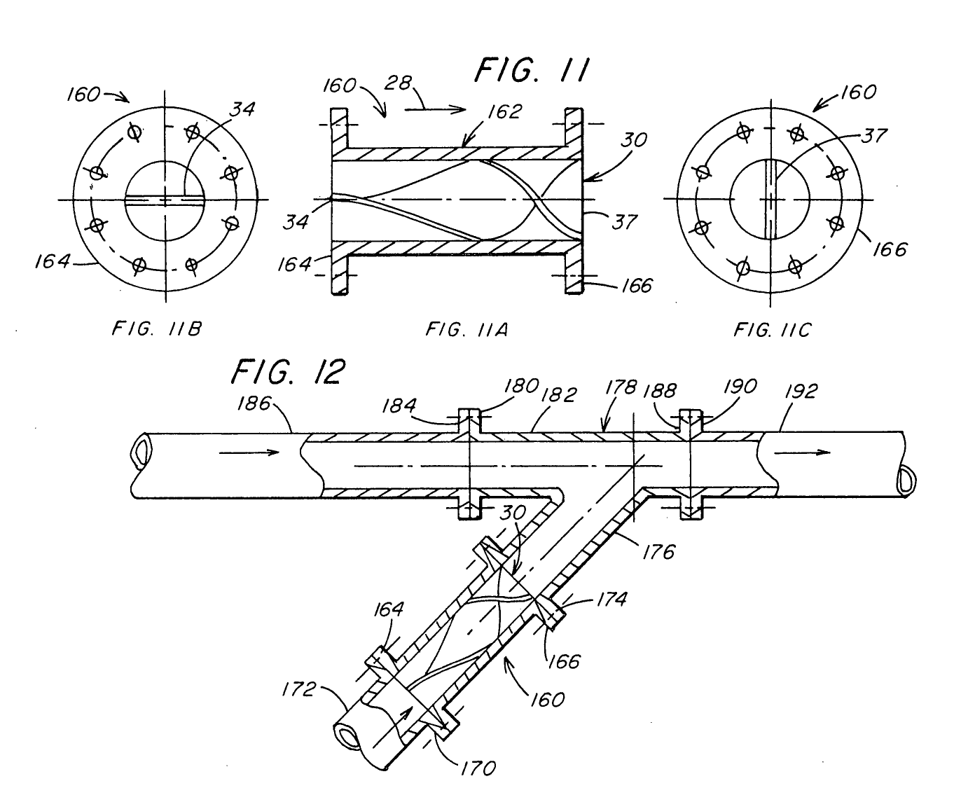

With reference to FIG. 9 there is shown a variable pitch mixing device 140 incorporating features of the invention. The mixing device 140 includes the variable pitch deflector 30 mounted inside body 142 of conduit, tube or pipe 143 having a pair of flanged ends 144 and 146. The mixing device 140 shown in FIG. 9 is similar to the mixing device 108 shown in FIG. 7 and discussed above except that the mixing device 140 shown in FIG. 9 has a flanged end at each end of the valve body 142, e.g., flanged ends 144 and 146, and the mixing device 108 has only one flanged end. With reference to FIG. 10, in one non-limiting embodiment of the invention, the flanged end 144 of the mixing device 140 can be connected to the flanged end 120 of the pipe 122 carrying the process fluids, and the other flanged end 146 of the mixing device 140 connected to the outer surface wall 124 of the tank 126. The connection of the flanged ends 120 and 144 and the tank wall 124 and flanged end 146 are made using suitable fasteners and gaskets (not shown) of the type used in the art. The details of operation of the process fluid exiting the flanged end 146 of the mixing device 140 as shown in FIG. 10 are substantially identical to the details of operation of the process fluid exiting the end 114 of the mixing device 108 discussed with reference to FIG. 8 above.

As discussed above with reference to FIG. 4, although it is preferred that end 68 of the pipe 60 extend beyond the end 37 of the deflector 30 by an amount approximating the inside diameter of the pipe to allow the swirling action to fully develop beyond the confines, i.e., downstream of the end 37 of the deflector 30 before discharging into a receiving media, e.g., a body of fluid (see FIG. 8), the length 69 of the pipe 70 (see FIG. 4) can be more than one pipe diameter and can be less than one pipe diameter. For example but not limiting to the invention, in applications where the downstream end of the mixing device discharges directly into a pipe, the additional tube length is not required to be part of the mixing device. More particularly and with reference to FIG. 11, there is shown a mixing device 160 including pipe, conduit, or tube 162 having flanged ends 164 and 166 and the deflector 30. The difference between the mixing device 140 shown in FIGS. 9 and 10, and the mixing device 160 shown in FIG. 11, is that the distance between the deflector end 37 and the flanged end 146 of the mixing device 140 is greater than the distance between the end 37 and the flanged end 166 of the mixing device 160. More particularly, the end 37 of the deflector 30 of the mixing device 160 is aligned with the end 166 as shown in FIG. 11. As can be appreciated, by eliminating a portion of the body 142 of the conduit 143 of the mixing device 140, the mixing device 160 is shorter and lighter than the mixing device 140.

With reference to FIG. 12, the mixing device 160 shown in FIG. 11 has flanged end 164 connected to flanged end 170 of pipe 172, and the flanged end 166 connected to flanged end 174 of pipe 176 of a Y-joint 178. Flanged end 180 of pipe 182 of the Y-joint 178 is connected to flanged end 184 of pipe 186. Flanged end 188 of the Y-joint 178 is connected to flanged end 190 of pipe 192. As can be appreciated, the connection of the flanged ends are made using gaskets and washers to prevent process fluid from leaking from the connections.

In practice, primary process fluid moves through the pipe 186 into pipe 182 of the Y-joint 178, secondary process fluid flows from the pipe 172 into and through the mixing device 160 into the pipe 176 of the Y-joint 178. When discharging into a pipe, e.g., the pipe 176 of the Y-joint 178, the separate flow paths through the deflector 30 re-combine into a single “swirling” flow in the downstream pipe, e.g., the pipe 176. Since the process fluid is constrained by the walls of the pipe 176, the fluid continues to rotate or swirl until it makes contact with the junction of the pipes 176 and 182 of the Y-joint 178 where it meets the primary flow entering the pipe 182 from the pipe 186. At this point, the rotating secondary flow from the pipe 176 generates an extensive controlled turbulence that enhances mixing of the two flow streams.

As can be appreciated, the arrangement shown in FIG. 12 is not limiting to the invention and is an illustration of a non-limiting embodiment of the use of the mixing devices of the invention. For example and not limiting to the invention, the mixing device and associated pipes can be the same size or different size, e.g., the inside diameters of the pipes 172 and 176 of the Y-joint 178, and the inside diameters of the pipes 176 and 182 of the Y-joint 178 can be the same or different inside diameter. Further, the primary flow can be through the pipe 172 and secondary flow can be through the pipe 186.

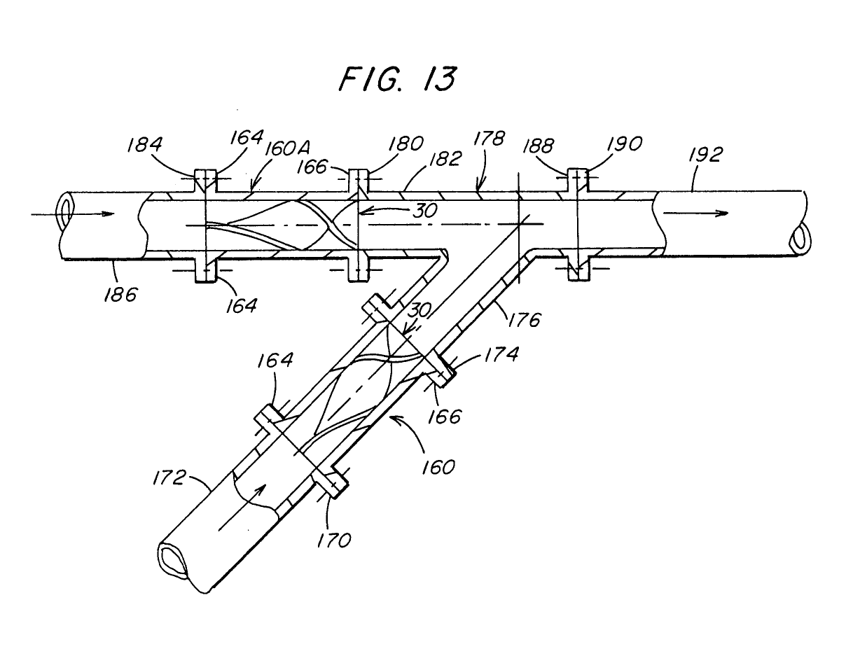

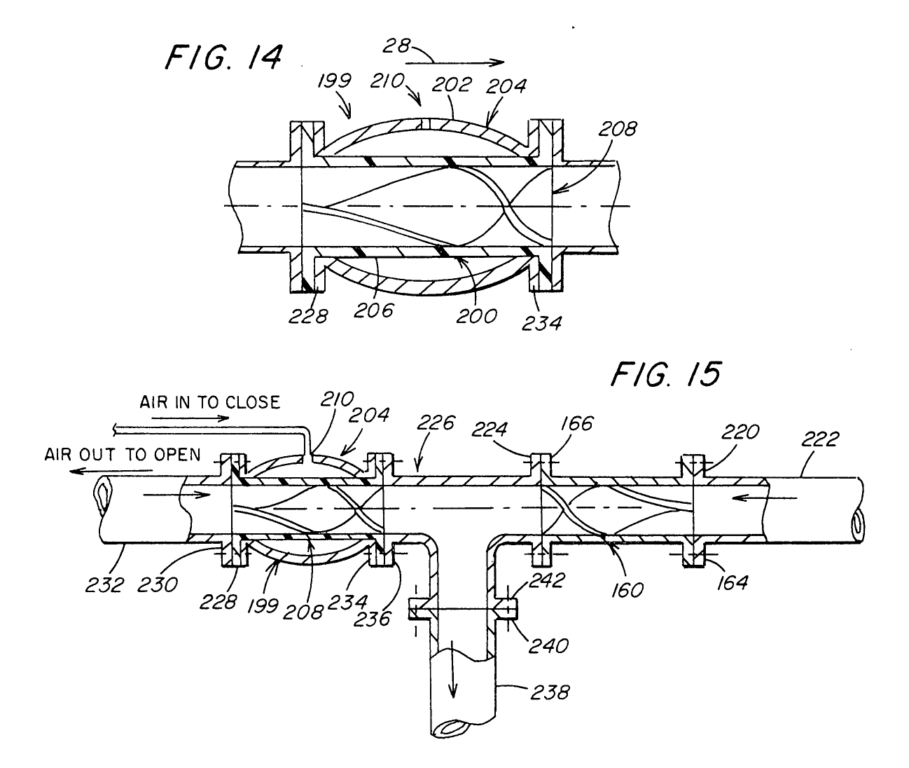

Shown in FIG. 13 is another non-limiting embodiment of the invention having a mixing device 160 in the secondary flow and in the primary flow. The flanged end 170 of the pipe 172 is connected to the flanged end 164 of the mixing device 160, and the flanged end 166 of the mixing device 160 is connected to the end 174 of the pipe 176 of the Y-joint 178 as previously discussed for FIG. 12. A second one of the mixing devices 160 designated by the number 160A in FIG. 13 has flanged end 164 connected to the flanged end 184 of the pipe 186, and the flanged end 166 connected to the flanged end 180 of the pipe 182 of the Y-joint 178. With the arrangement shown in FIG. 13, the twisting primary process fluid flowing from the mixing device 160A and the twisting secondary process fluid from the mixing device 160 blend in the Y-joint 178 and flow as a combined fluid into the pipe 192. A mixing device operating on each of the primary and secondary fluids provides more enhanced mixing when the fluids combine in the Y-joint.

As can be appreciated, each of the deflectors 30 of the mixing devices 160 and 160A can twist the fluid in a clockwise or counterclockwise direction, or one deflector of a mixing device, e.g., device 160, can twist the fluid in a clockwise direction and the other mixing device, e.g., 160A, can twist the fluid in a counterclockwise direction. Further, the mixing devices 160 and 160A can be different sizes, e.g., diameters and length. Still further, the mixing devices 160 and 160A can have different deflection, e.g., the mixing device 160A can have a fixed pitch helical deflector of the type shown in FIG. 1 or can have a tapered or conical helical deflector of the type shown in FIG. 5.

In another non-limiting embodiment of the invention, the components of the mixing device, e.g., the body of the pipe and the deflector mounted in the body of the pipe, are fabricated using a flexible material, such as an elastomer or fabric-reinforced elastomer. The mixing device can be put in an open position, a closed position, and intermediate positions between the open and closed positions using a pinch valve, e.g. but not limiting the invention thereto, a pinch valve of the type sold by Red Valve Company, Inc. of Carnegie, Pa. and listed as a Type “A” Pinch Valve in their catalog titled Red Valve Control Valve No. CV1/01.

More particularly and with reference to FIG. 14 there is shown an air-operated mixing valve 199 incorporating features of the invention. The air-operated valve 199 includes a flexible mixing device 200 similar to device 160 shown in FIG. 11 mounted within a rigid metal housing 202 of a pinch valve 204. The housing 202, which is the pressure-containing body of the pinch valve 204, can be made of any rigid material, e.g. but not limiting the invention thereto, an elastomer or fabric-reinforced elastomer, and is preferably made of iron or steel. A body 206 of the mixing device 200 preferably has a circular cylindrical shape; however, the invention contemplates a tapered cylinder and/or a body having an elliptical, polygonal, or other shaped cross section. Deflector 208 preferably has a variable helical pitch, e.g., similar to the deflector 30 shown in FIG. 2; however, the invention contemplates a deflector having other configurations, e.g., the deflector can be a fixed pitch helix, flat plates, curved plates, circular holes, to name a few. Further, the invention contemplates using the mixing devices having passageways molded in a conduit, e.g. but not limiting to the invention, the mixing device 90 shown in FIG. 6. The elastomer material of the body 206 and deflector 208 can also be reinforced with fabric, as is well known in the art.

The mixing device 200 is closed or opened by applying fluid pressure or relieving fluid pressure, e.g. but not limiting to the invention, air pressure between the outside of the body 206 of the mixing device 200 and the inside of the housing 202 of the pinch valve 204. More particularly, pressure is moved into the housing 202 to collapse the body 206 of the mixing device 200 and the deflector 208 to stop the flow through the mixing device 200. The air pressure is moved out of a pressure valve 210, the body 206, and the body 206 and the deflector 208 of the mixing device 200 returns to their non-biased shape to move fluid through the mixing device. Tests conducted on a 4-inch (10.16 cm) diameter pinch-type-mixing valve used an operating air pressure of 15 pounds per square inch (“psi”) (1 kilogram/square cm) greater than the internal line pressure of the mixing device to fully close the mixing device. By controlling the operating air pressure between zero and 15 psi (1 kilogram/square cm) above the line pressure, the pinch valve can be used to both mix and throttle an additive to a primary process fluid flow.

With reference to FIG. 15 there is shown an arrangement for blending a secondary flow into a primary flow using both the air-operated mixing valve 199 shown in FIG. 14 with an uncontrolled mixing device, e.g., the mixing device 160 shown in FIG. 11. The flanged end 164 of the mixing device 160 is connected to flanged end 220 of pipe 222 carrying a primary fluid flow, and the flanged end 166 of the mixing device 160 connected to flanged end 224 of a T-joint 226. The air-operated mixing valve 199 has flanged end 228 jointed to flanged end 230 of pipe 232 carrying a secondary flow and flanged end 234 of the air-operated valve 199 connected to second flanged end 236 of the T-joint 226. A pipe 238 has its flanged end 240 connected to third flanged end 242 of the T-joint 226. As an example but not limiting to the invention, the pipe 232 carrying the secondary flow is moving lime slurry to neutralize an acidic effluent flowing through the pipe 222 carrying the primary flow. In this example, the air-operated mixing valve 199 is operated to compress the flexible mixing device 200 to stop the flow of lime slurry, or to allow the flexible mixing device 200 to expand to a position where the amount of lime slurry introduced compensates for the quantity and pH of the primary flow by monitoring the pH of the combined flow.

An additional advantage of the air-operated mixing device is the ability to dislodge accumulated compacted crust inside the mixing device. Lime slurry is disposed to caking and accumulating inside piping and valves. By cycling the air-operated mixing device several times from fully open to fully closed, the encrusted lime is broken up and released from the inner walls of the mixing device.

As can be appreciated, the T-joint can be replaced with a Y-joint and vice versa. Further, any of the deflectors discussed herein and combinations thereof can be used in the piping arrangements of FIGS. 12, 13, and 15.

As can be appreciated by those skilled in the art, in many applications for mixing devices, it is desirable and sometimes essential to prevent back flow of process fluid through the mixing device. For example, when discharging into an ocean or bay under low flow or zero flow conditions, marine growth, e.g., mussels, algae, etc., can enter the mixing device and adhere to the internal surfaces of the mixing device. Installing a separate check valve upstream of the mixing device will prevent back flow of process fluid past the point that the check valve is installed; however, it will not prevent back flow of process fluid into the mixing device. Further, installing a separate check valve downstream of the mixing device can, depending on the specific design and characteristics of the check valve, negate some or all of the benefits of the mixing features of the mixing device.

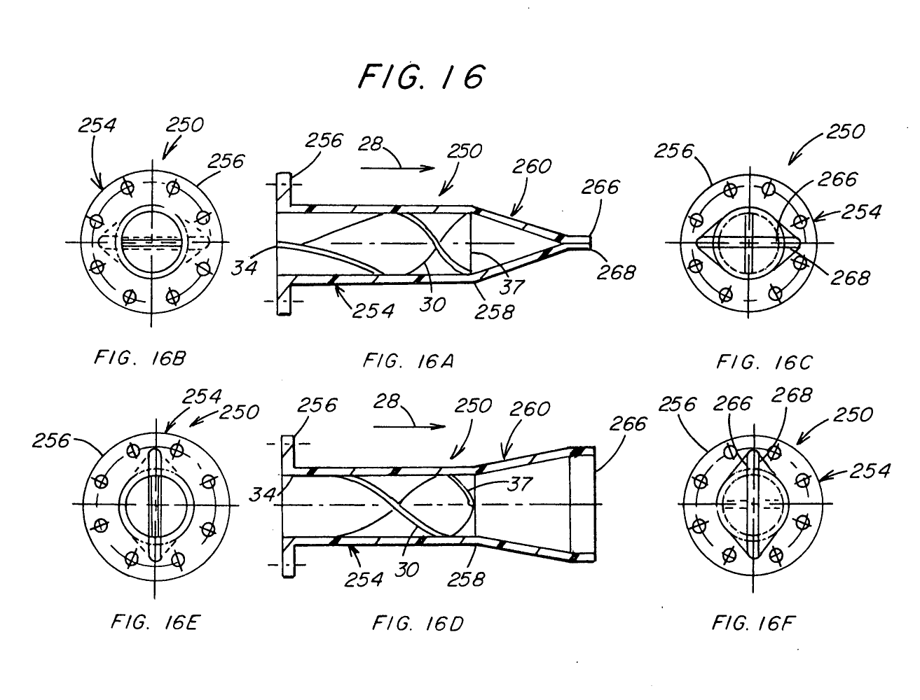

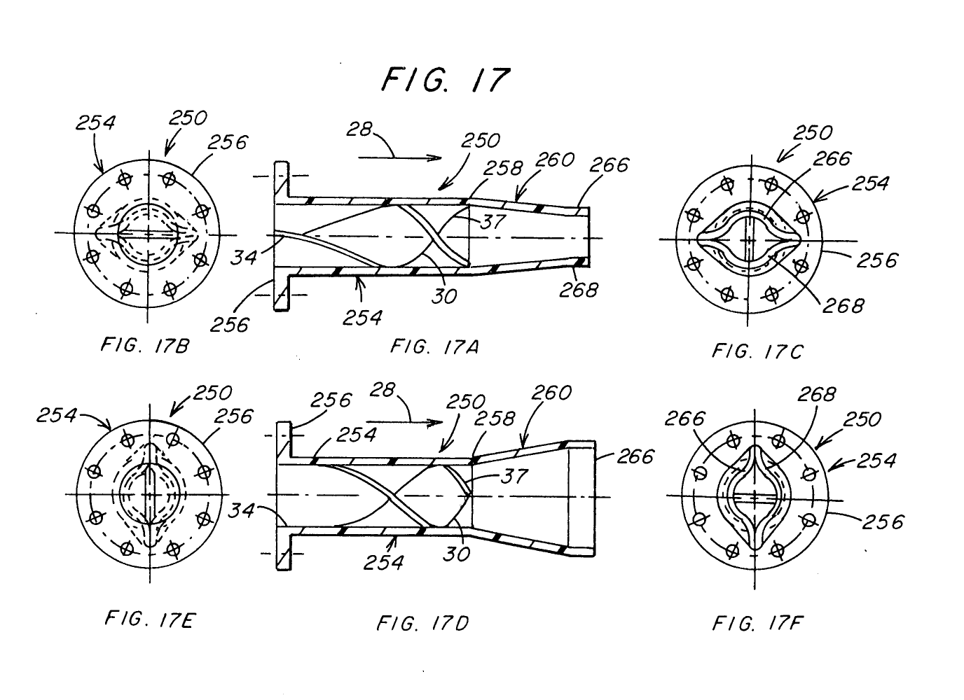

In accordance to a non-limiting embodiment of the invention, mixing devices of the invention include control valves to control or limit fluid back flow into the mixing device. As can be appreciated, the invention is not limited to the type of check valves that can be used with the mixing devices of the invention to control the flow, e.g., fluid back flow through the mixing device. For example and not limiting to the invention, shown in FIGS. 16 and 17 is a mixing device 250 incorporating features of the invention. The mixing device 250 includes a deflector, e.g. but not limiting to the invention, a 4-inch (10.16 cm) variable pitch deflector 30 shown in FIG. 2 mounted inside a pipe 254 having a flanged inlet end 256 adjacent to the end 34 of the deflector 30. Opposite or downstream end 258 of the conduit 254 has a check valve 260, e.g., in this non-limiting embodiment of the invention a “duck bill” check valve 260. The “duck bill” valve or any check valve can be formed with the pipe 254, or the pipe 254 and the check valve 260 can be two discrete pieces joined together in any convenient manner. Incorporating the check valve with the mixing device provides an integrated device where the characteristics of the mixing device and check valve can be optimized to work cooperatively as a matched set. This also has the advantage of reducing installation costs since there is only one component to install, instead of two, along with the associated hardware and fastening devices. The end 37 of the deflector 30 can be aligned as shown in FIGS. 16 and 17 with or spaced from the downstream end 258 of the pipe 254. In FIG. 16, lips 266 and 268 of the check valve 260 are in the closed position, and in FIG. 17, the lips 266 and 268 of the check valve 260 are in the open position.

The “duck bill” valve 260 used in the practice of the invention can be any of the types known in the art. For example and not limiting to the invention, the “duck bill” valve can be of the type manufactured by Red Valve Company, Inc., Carnegie, Pa. and sold under the registered trademark TIDEFLEX, and of the type disclosed in U.S. Pat. No. 4,607,663 incorporated herein by reference. “Duck bill” valves are well known in the art and a detailed discussion of the operation of “duck bill” valves is not deemed necessary.

As can be appreciated by those skilled in the art, by designing a check valve of appropriate dimensions and construction, for example providing the lips 266 and 268 with thin walls of low durometer elastomer, the lips of the check valve, when open due to fluid flow through the mixing device, will open to a shape approximating the downstream end 258 of the conduit 254 of the mixing device, e.g. and not limiting to the invention, the lips 266 and 268 of the valve 260 will open to a circular cylindrical shape. Although not limiting to the invention, the lips 266 and 268 of the duck bill valve 260 in the open position have a hollow circular cone having a cross-sectional area smaller than the internal cross-sectional area of the pipe itself. This reduced cross-sectional area results in an exit jet velocity greater than the entrance jet velocity to the valve. This higher jet velocity also increases the mixing between the process fluid and receiving fluid. It is of particular importance that this higher velocity is achieved without significantly reducing the size of the exit opening when injecting slurries containing large particulate matter. Slurries containing large particulate matter tend to clog small exit orifices. The “duck bill” valve 260 shown in FIGS. 16 and 17 is an example of a “two-sided closure.” As can be appreciated, the invention is not limited thereto and the invention contemplates “four or more sided closures”. Also, any of the other mixing devices shown and/or contemplated herein can be used with the check valve shown in FIGS. 16 and 17 and/or any type of check valve design without departing from the scope of the invention.

As can be appreciated, the invention is not limited to the non-limiting embodiments discussed above, and the non-limiting embodiments are present for purposes of illustration and not of limitation. It is understood that various changes can be made without departing from the teachings of the invention defined by the claimed subject matter that follows.

The invention claimed is:

1. A deflector for a fluid mixing device of the type having a pipe, a first end, a second end, and a cavity between the first and second ends, the deflector comprising:
a helical-shaped body comprising a first end and a second end; the body having two channels between the first and second ends of the body with the two channels isolated from one another, wherein with the deflector in the cavity of the pipe, the two channels and surface of the cavity of the pipe form a first passageway connecting the first end and the second end of the pipe, and a second passageway connecting the first end and the second end of the pipe with the first and second passageways isolated from one another and in a spaced relationship to one another.

2. The deflector according to claim 1 wherein the helical path of the first and second channels of the helical-shaped body each rotate through 270 degrees between the first end and the second end of the helical-shaped body.

3. The deflector according to claim 2 wherein the helical-shaped body has a location between the first and the second ends of the helical-shaped body where the helical path of the first and second channels from the first end of the helical-shaped body to the location rotates through 180 degrees and from the location to the second end of the helical-shaped body rotates through 90 degrees.

4. The deflector according to claim 2 wherein the location is selected from the group of (A) a distance from the first end of the helical-shaped body equal to ⅔ the distance between the first end and the second end, and the location is a distance from the second end of the helical-shaped body equal to ⅓ the distance between the first end and the second end to provide a fixed pitch helical deflector and (B) a distance from the first end of the helical-shaped body greater than ⅔ the distance between the first end and the second end, and the location is a distance from the second end of the helical-shaped body less than ⅓ the distance between the first end and the second end to provide a variable pitch deflector.

5. A fluid mixing device comprising:
a pipe comprising:
a first end and a second end;
a first passageway within the pipe connecting the first end and the second end; and
a second passageway within the pipe connecting the first end and second end, the first and second passageways isolated from one another and in a spaced relationship to one another,
wherein each of the passageways defines a hollow helical path along a length of said pipe.

6. The mixing device according to claim 5, wherein the pipe is a one-piece molded pipe and the first and second passageways are spaced from one another.

7. The mixing device according to claim 5, wherein the pipe has an interior cavity between and interconnecting the first end and second end, the cavity having an interior surface, and further comprising a deflector securely mounted in the cavity of the pipe between the first end and the second end of the pipe to separate the cavity of the pipe into the first passageway and second passageway.

8. The mixing device according to claim 7, wherein the deflector comprises a first major surface and an opposite second major surface; a first end and an opposite second end, with the first end of the deflector in a fixed relationship to the first end of the pipe and the second end of the deflector in a fixed relationship to the second end of the pipe, and the first surface of the deflector and adjacent portions of the interior surface of the pipe providing inner walls of the first passageway and the second surface of the deflector and adjacent portions of the interior surface of the pipe providing inner walls of the second passageway.

9. The mixing device according to claim 8, wherein the first end of the deflector and the first end of the pipe are spaced from one another.

10. The mixing device according to claim 9, wherein the cavity of the pipe has a diameter and the distance between the first end of the deflector and the first end of the pipe is equal to or greater than the diameter of the interior hollow body of the pipe.

11. The mixing device according to claim 9, wherein the cavity of the pipe has a diameter and the distance between the first end of the deflector and the first end of the pipe is equal to or less than the diameter of the cavity of the pipe.

12. The mixing device according to claim 7, wherein the first end of the pipe has a first inside diameter and the second end of the pipe has a second inside diameter, with the first inside diameter greater than the second inside diameter, and the diameter of the cavity of the pipe decreases as the distance from the first end to the second end of the pipe increases.

13. The mixing device according to claim 7, wherein the pipe and the deflector are made of a compressible material, and further comprising:
a housing having a first end and a second end;
the pipe having the deflector mounted in the housing, with the first end of the pipe connected to the first end of the housing and the second end of the pipe connected to the second end of the housing to provide a sealed chamber between inner surface of the housing and outer surface of the pipe; and
an opening in the wall of the housing for moving a fluid into the chamber to compress the pipe and the deflector, and for moving the fluid out of the chamber.

14. The mixing device according to claim 7, further comprising a duck bill valve connected to the first end of the pipe.

15. The mixing device according to claim 7, wherein the helical path of the first and second passageways each rotate through 270° between the first end and the second end of the deflector.

16. The mixing device according to claim 15, wherein the deflector has a location between the first and the second end, where the helical path of the first and second passageways from the first end of the deflector to the location rotates through 180° and from the location to the second end of the deflector rotates through 90°.

17. The mixing device according to claim 16, wherein the location is a distance from the first end of the deflector equal to ⅔ the distance between the first end and the second end of the deflector, and the location is a distance from the second end of the deflector equal to ⅓ the distance between the first end and the second end of the deflector to provide a fixed pitch helical deflector.

18. The mixing device according to claim 16, wherein the location is a distance from the first end of the deflector greater than ⅔ the distance between the first end and the second end of the deflector, and the location is a distance from the second end of the deflector less than ⅓ the distance between the first and second end of the deflector to provide a variable pitch deflector.

19. A mixing system comprising:
a first mixing device comprising:
a pipe comprising:
a first end and a second end;
a first passageway within the pipe connecting the first end and the second end; and
a second passageway within the pipe connecting the first end and second end, the first and second passageways isolated from one another and in a spaced relationship to one another,
wherein each of the passageways defines a hollow, helical path as the distance from the first end toward the second end increases;
a second mixing device comprising:
a pipe comprising:
a first end and a second end;
a first passageway within the pipe connecting the first end and the second end; and
a second passageway within the pipe connecting the first end and second end, the first and second passageways isolated from one another and in a spaced relationship to one another,
wherein each of the passageways defines a hollow helical path as the distance from the first end toward the second end increases; and
piping connecting the second end of the pipe of the first mixing device to the second end of the pipe of the second mixing device.

20. The mixing system according to claim 19, wherein the first mixing device is made of a compressible material, and further comprising:
a housing having a first end and a second end;
the first mixing device mounted in the housing, with the first end of the first mixing device connected to the first end of the housing and the second end of the mixing device connected to the second end of the housing to provide a sealed chamber between inner surface of the housing and outer surface of the first mixing device; and
an opening in the wall of the housing for moving a fluid into the chamber to compress the first mixing device, and for moving the fluid out of the chamber.
